(19) United States
(12) Patent Application Publication
(10) Pub. No.: US 2002/0110165 A1
(43) Pub. Date: Aug. 15, 2002

(54) Method and system for cooling at least one laser diode with a cooling fluid

(76) Inventor: David M. Filgas, Newbury Park, CA (US)

Correspondence Address: David R. Syrowik, Brooks & Kushman P.C., 22nd Floor, 1000 Town Center, Southfield, MI, 48075-1351, US

(21) Appl. No.: 09/783,208

(22) Filed: Feb. 14, 2001

(51) Int. Cl. H01S 3/04

(52) U.S. Cl. 372/36

(57) ABSTRACT

A method and system for cooling at least one laser diode with a cooling fluid which does not come into direct contact with the at least one laser diode is presented. Liquid cooled heat sinks are provided on opposing sides of each laser diode. Individual modules are held together by a single holding mechanism allowing individual modules to be removed from the array for easy testing or replacement.

### TECHNICAL FIELD

The present invention relates to methods and systems for cooling at least one laser diode with a cooling fluid.

### BACKGROUND ART

Use of laser diodes in many applications is growing due in part to the advantages of these lasers over more conventional lasers. Laser diodes are more compact, consume less power and are relatively efficient and reliable. Typically about 40% to 50% of the electrical power to a laser diode is converted to laser output, and the remaining 60% to 50% of the electrical input power is dissipated as heat in the diode, thus raising its temperature. As the temperatures of the diode increases, the conversion efficiency of electrical input to optical output falls so that, for a fixed electrical input, laser output declines. Also, as the temperature of the laser diode rises, the risk of the laser diode “failing” (i.e., ceasing to operate) increases. Furthermore, as electrical input power is increased (in order to increase output power), the heat dissipated in the laser diode increases, thus increasing its temperature. Consequently, careful thermal management is necessary for reliable high power operation.

To operate a laser diode at high power, a cooling mechanism must be used to lower the diode temperature. This is highly desirable since laser diodes that are operated at lower temperature have longer operational life and higher conversion efficiency. Thus with good cooling of the laser diode, the output power will be higher for a given input, and the laser diode will survive for a longer period of time.

Many laser diode applications require higher output powers than can be achieved from single laser diodes. For these applications multiple laser diodes are commonly grouped into large one or two dimensional arrays.

Laser diodes used for high power operation are typically rectangular bars with approximate dimensions of 1mm×10 mm×0.15 mm. Laser output is emitted from one of the 110 mm×0.15 mm surfaces. The two opposing 1 mm×10 mm surfaces (hereinafter “sides”) each have a metal coating and serve as anode and cathode for making electrical connections to the diode. At least one of the two 1 mm×10 mm sides is also used for mounting and cooling the laser diode.

Laser diode cooling mechanisms that only cool on one side of the diode (see U.S. Pat. Nos. 6,091,746 titled “Assembly of cooled laser diode arrays” issued on Jul. 18, 2000 and 5,105,429 titled “Modular package for cooling a laser diode” issued on Apr. 14, 1992) offer sub-optimal operating temperatures.

Prior art laser diode cooling mechanisms that provide cooling on both sides of the diode (see U.S. Pat. No. 5,495,490 titled “Immersion method and apparatus for cooling a semiconductor laser device” issued on Feb. 27, 1996) typically do not have a modular structure. In this type of cooling arrangement, laser diodes are soldered directly to heatsinks in a configuration that places a single heat sink between two laser diodes. This design does not allow diodes to be individually tested before assembly into the array. If a single laser diode should fail before other laser diodes in such an array there is no easy mechanism by which that diode can be replaced. Further, if a single diode in an array malfunctions there is no mechanism available by which individual diodes can be tested to determine which diode is malfunctioning.

A modular laser diode package with cooling on both sides of the diode is disclosed in U.S. Pat. No. 5,913,108 (titled “Laser Diode Package” issued on Jun. 15, 1999). However, the heatsinks in this package are cooled only by conduction and cannot remove heat as efficiently as typical convection cooled heat sinks.

The following U.S. Pat. Nos. are also related to diode laser packaging designs: 5,985,684; 5,898,211; 5,903,583; 5,987,043; 5,930,279; 5,923,692; 5,909,458; 5,848,082; 5,835,518; 5,828,683; 5,764,675; 5,734,672; 5,627,850; 5,520,244; and 5,309,457.

### SUMMARY OF THE INVENTION

It is an object of the present invention to provide an improved method and system for cooling at least one laser diode with a cooling fluid.

In carrying out the above object and other objects of the present invention, a method for cooling at least one laser diode with a cooling fluid which does not come into direct contact with the at least one laser diode is provided. The method includes providing a source of cooling fluid. The method also includes positioning heat sinks on opposing sides of the at least one laser diode wherein each of the heat sinks has a passage formed therein. The passages are in fluid communication with the source of cooling fluid but not with the at least one laser diode. The method further includes circulating the cooling fluid through the passages wherein heat is removed from the sides of the at least one laser diode by conduction into the heat sinks. Heat is removed from the heat sinks by the cooling fluid via forced convection.

The method may further include the step of electrically and thermally bonding the heat sinks to the at least one laser diode.

The heat sinks may serve as electrical connections to and from the at least one laser diode.

At least one of the heat sinks may have a heat spreader which is positioned adjacent the at least one laser diode. The heat spreader may be made of a material different than the material of the at least one heat sink.

In further carrying out the above object and other objects of the present invention, a method for cooling an array of laser diodes with a cooling fluid which does not come into direct contact with the laser diodes is provided. The method includes providing a source of cooling fluid. The method also includes positioning heat sinks on opposing sides of each of the laser diodes such that each heat sink is in contact with a single laser diode. Each of the heat sinks has a passage formed therein. The passages are in fluid communication with the source of cooling fluid but not with the laser diodes. The method further includes circulating the cooling fluid through the passages wherein heat is removed from the sides of each of the laser diode by conduction into the heat sinks. Heat is removed from the heat sinks by the cooling fluid via forced convection.

The method may further include the step of electrically and thermally bonding the heat sinks to their respective laser diodes.

The heat sinks may serve as electrical connections to and from their respective laser diodes.

Each of the heat sinks for a given laser diode may be in electrical contact with either a heat sink associated with a different laser diode or with an electrical supply such that multiple laser diodes are electrically connected in series or in parallel.

At least one of the heat sinks may have a heat spreader which may be positioned adjacent its laser diode. The heat spreader may be made of a material different than the material of the at least one heat sink.

Still further in carrying out the above object and other objects of the present invention, a system for cooling at least one laser diode with a cooling fluid which does not come into direct contact with the at least one laser diode is provided. The system includes a source of cooling fluid. The system further includes a plurality of heat sinks in thermal contact with opposing sides of the at least one laser diode. Each of the heat sinks has a passage formed therein. The passages are in fluid communication with the source of cooling fluid but not with the at least one laser diode. The system further includes a mechanism for circulating the cooling fluid through the passages wherein heat is removed from the sides of the at least one laser diode by conduction into the heat sinks. Heat is removed from the heat sinks by the cooling fluid via forced convection.

The system may further include a support structure for supporting the heat sinks. The support structure may include at least one cooling liquid line fluidly coupled to the passages of the heat sinks.

Each of the passages may include a flow inlet and a flow outlet wherein the flow inlets are fluidly coupled to each other and the flow outlets are fluidly coupled to each other.

The system may further include a support structure for supporting the heat sinks. The support structure may include a cooling liquid supply line fluidly coupled to each of the flow inlets and a cooling liquid return line fluidly coupled to each of the flow outlets.

The heat sinks may be bonded to the at least one laser diode with solder or an electrically and thermally conducting adhesive.

Further in carrying out the above object and other objects of the present invention, a system for cooling an array of laser diodes with a cooling fluid which does not come into direct contact with the laser diodes is provided. The system includes a source of cooling fluid. The system further includes a plurality of heat sinks in thermal contact with opposing sides of each of the laser diodes. Each heat sink is in contact with a single laser diode. Each of the heat sinks has a passage formed therein wherein the passages are in fluid communication with the source of cooling fluid but not with the laser diodes. The system further includes a mechanism for circulating the cooling fluid through the passages wherein heat is removed from the sides of each of the laser diodes by conduction into the heat sinks. Heat is removed from the heat sinks by the cooling fluid via forced convection.

The system may further include a support structure for supporting the heat sinks. The support structure may include at least one cooling liquid line fluidly coupled to the passages of the heat sinks.

Each of the passages may include a flow inlet and a flow outlet wherein the flow inlets are fluidly coupled to each other and the flow outlets are fluidly coupled to each other.

The system may further include a support structure for supporting the heat sinks. The support structure may include a cooling liquid supply line fluidly coupled to each of the flow inlets and a cooling liquid return line fluidly coupled to each of the flow outlets.

The system may further include at least one fastener for removably fastening the heat sinks together.

The heat sinks may be bonded to their respective laser diodes with solder or an electrically and thermally conducting adhesive.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

Embodiments of the present invention will be described by way of example in conjunction with the drawings in which:

FIG. 1a is a front view of a laser diode cooling module according to an embodiment of the present invention;

FIG. 1b is a side view of the module of FIG. 1a with a laser diode mounted between heat sinks of the module;

FIG. 1c is a back view of the module of FIG. 1b;

FIG. 1d is a sectional view of the module taken along lines 1d-1d in FIG. 1c;

FIG. 2a is a front view of one of the heat sinks of the module of FIGS. 1a-1d and also illustrating mounting locations for a laser diode and an insulator;

FIG. 2b is a side view of the heat sink of FIG. 2a;

FIG. 2c is a sectional view of the heat sink of FIG. 2b taken along lines 2c-2c;

FIG. 2d is a back view of a second one of the heat sinks of the module;

FIG. 2e is a sectional view of the heat sinks of 2d taken along lines 2e-2e;

FIG. 3 is a sectional view of a stacked laser diode array arrangement using the laser diode cooling module of FIGS. 1c-1d;

FIG. 4a is a side view of a side-by-side laser diode array arrangement using the laser diode cooling module of FIGS. 1c-1d;

FIG. 4b is a top view of the side-by-side laser diode array of FIG. 4a;

FIG. 4c is an end view of the side-by-side laser diode array of FIG. 4a;

FIG. 5 is a sectional view similar to FIG. 1d but also showing a heat spreader; and

FIG. 6 is a side view of a cooling module modified to cool two diode bars.

### DETAILED DESCRIPTION OF THE PREFERRED EMBODIMENT(S)

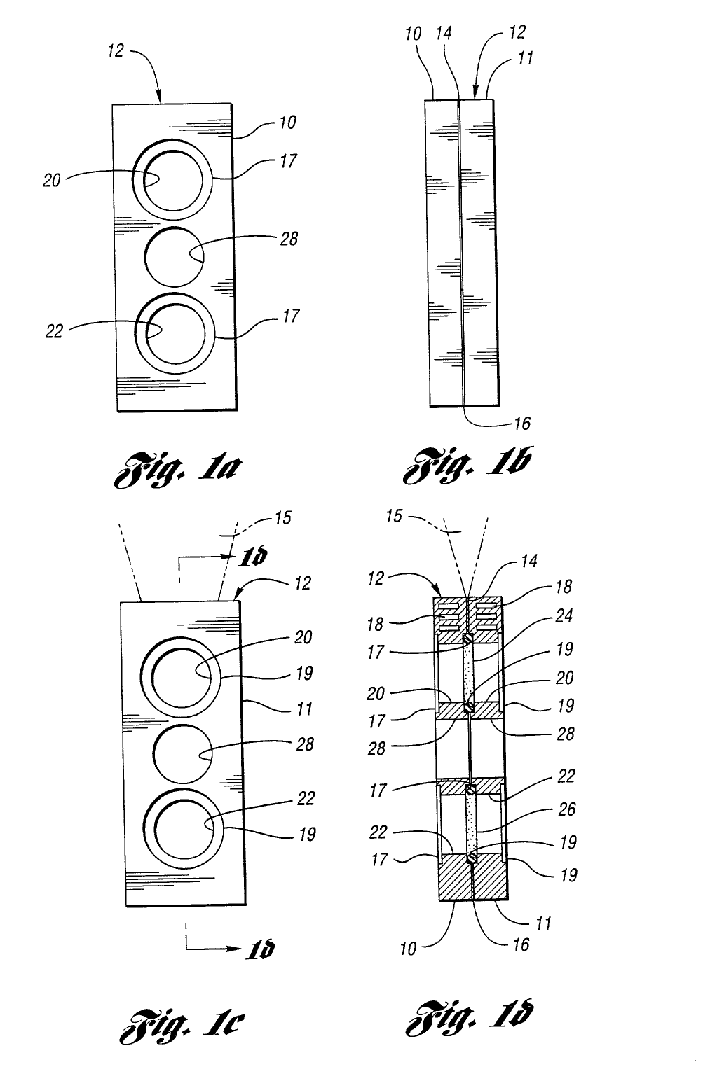

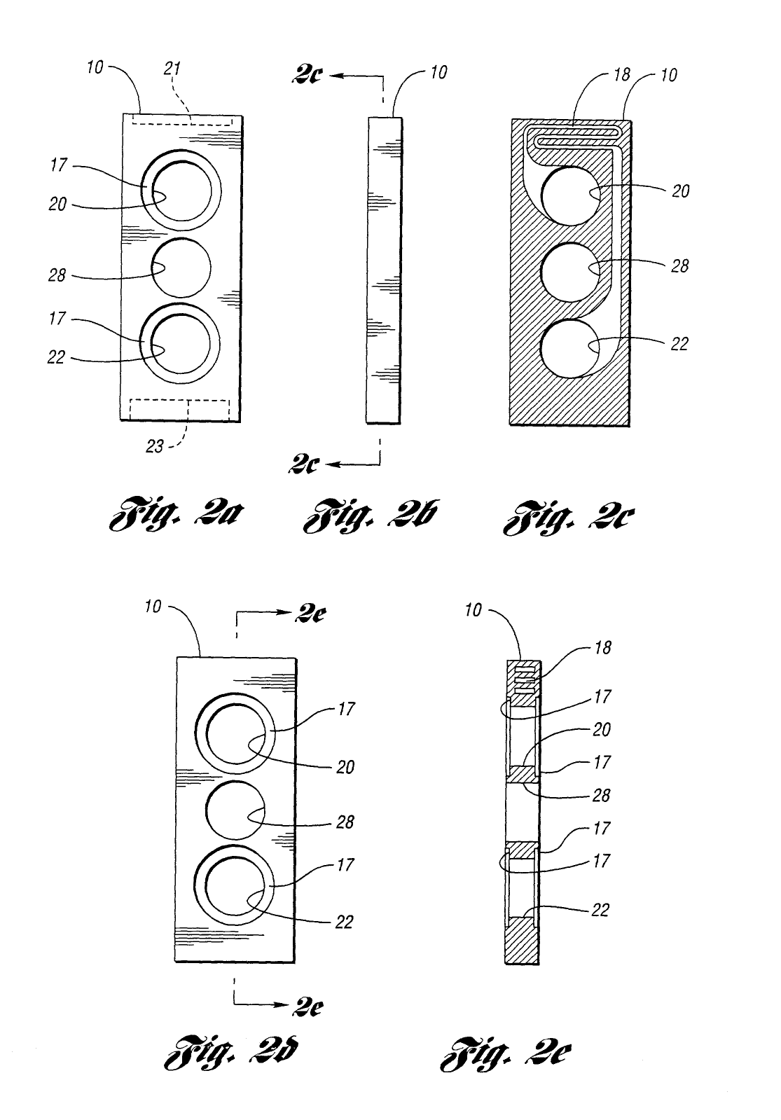

FIGS. 1c-1d illustrate a laser diode cooling module, generally indicated at 12, having liquid cooled, anode and cathode heat sinks 10 and 11, respectively, on opposing surfaces of a laser diode 14 having a laser output 15 according to an embodiment of the present invention. The laser diode 14 is solidly mounted between the two heat sinks 10 and 11 (collectively a cooling body) by way of, for example, solder or thermally and electrically conductive adhesive (e.g. epoxy cement). Separating the two heat sinks 10 and 11, in addition to the laser diode 14, is an insulating spacer 16 that electrically insulates the two heat sinks 10 and 11 from one another. The only conducting path between the two heat sinks 10 and 11 is through the laser diode 14. The insulating spacer 16 is solidly mounted between the two heat sinks 10 and 11 by, for example, solder or an adhesive. O-ring seals 24 and 26 are also located between the heat sinks 10 and 11 disposed in O-ring glands 17 and 19 formed in opposing faces of the heat sinks 10 and 11, respectively, as described in detail hereinbelow.

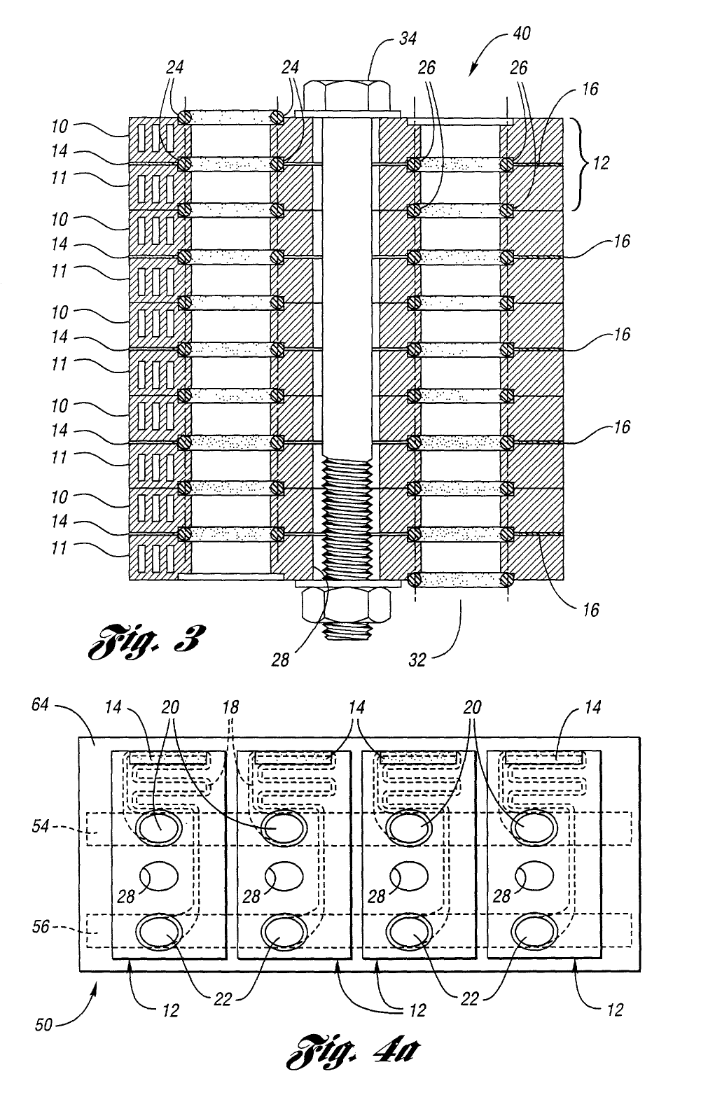

FIGS. 2a-2c are various views of the heat sink 10 wherein FIG. 2a shows a mounting location 21 for the laser diode 14 on top of the heat sink 10 and a mounting location 23 for the insulator 16. The heat sink 10 is electrically conducting and is preferably composed of a material of a higher thermal conductivity than the thermal conductivity of the laser diode 14, such as copper. However, it is to be understood that the heat sinks 10 and 11 may be made of a material which is not electrically conducting, such as silicon. In this case, the heat sinks 10 and 11 would have an electrically conducting coating applied to their surface to make electrical connections to and from the laser diode 14.

The laser diode 14 is positioned adjacent cooling channels 18 in the heat sinks 10 and 11 for cooling the laser diode 14. Cooling liquid, for example, water, flows through the cooling channels 18 in order to cool the heat sinks 10 and 11. The cooling liquid is not only electrically insulating (i.e. has low electrical conductivity), but also has high thermal capacity and is compatible with the other materials used.

Each of the cooling channels 18 preferably has a width on the order of 100 to 500 microns. Each cooling channel 18 provides a surface area in contact with the cooling fluid that is substantially larger than the surface area of the laser diode 14 in contact with the heat sinks 10 and 11.

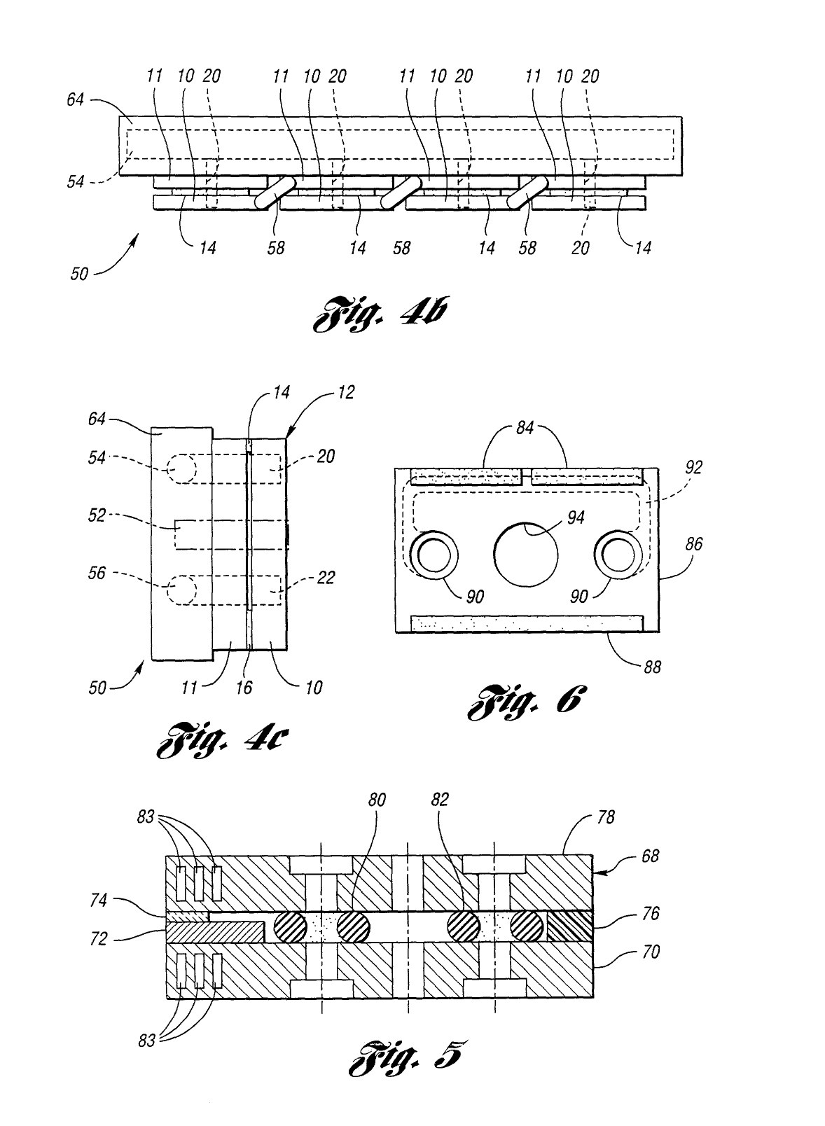

A flow inlet 20 and a flow outlet 22 formed in each of the heat sinks 10 and 11 are situated at opposite ends of its cooling channel 18 for supplying its cooling channel 18 with cooling liquid and removing the liquid once it has passed through its cooling channel 18. Each flow inlet 20 and outlet 22 are sealed with their respective cooling liquid supply and return by fluid seals, such as the O-ring seals 24, 26. It is to be understood that a gasket or other form of fluid seal could be used as well. A bolt hole 28 is situated in close proximity to the center of each of the heat sinks 10 and 11 for attaching the diode modules 12 together in an array, as shown in FIG. 3, or for attaching the modules 12 to a support structure 64, as shown in FIGS. 4a-4c.

FIG. 3 shows a stacked array, generally indicated at 40, arrangement of laser diode cooling modules 12 wherein the flow inlets 20 and flow outlets 22 in adjacent modules 12 are connected. The modules 12 are connected and held together by a bolt 34 through aligned bolt holes 28 in the heat sinks 10 and 11. The bolt 34 is not in electrical contact with the heat sinks 10 and 11. The bolt 34 can be composed of an electrically insulating material or, alternatively, surrounded by an electrically insulating tube.

All flow inlets 20 are connected along a single line in series to each other with O-ring seals 24 sealing the connection between the flow inlets 20. All flow outlets 22 are connected along a single line in series to each other with O-ring seals 26 sealing the connection between the flow outlets 22. A liquid cooling supply 30 provides cooling liquid to the inlets 20 of all heat sinks 10 and 11. A liquid cooling return 32 provides an outlet for the used cooling liquid for all outlets 22 from all heat sinks 10 and 11.

The heat sinks 10 and 11 serve as electrodes, providing electrical connection to the diodes 14. To force current to pass through each diode 14, the heat sinks 10 and 11 in each module 12 must be electrically separated from one another. The heat sinks 10 for one diode 14 are in electrical contact with heat sinks 11 for adjacent diodes 14. As previously mentioned, the heat sink 10 acts as an anode and the adjacent heat sink 11 acts as a cathode.

FIGS. 4a to 4c show a side-by-side array, generally indicated at 50, arrangement of laser diode modules 12 wherein flow inlets 20 and flow outlets 22 are connected to the support structure 64. The views in FIGS. 4a to 4c of the side-by-side array 50 are perpendicular to one another. Bolts 52 passing through the holt holes 28 in each laser diode module 12 (i.e., FIG. 4c) hold the modules 12 to the support structure 64. The bolts 52 are electrically insulated from the laser diode modules 12. The flow inlets 20 for each laser diode module 12 are connected in parallel to a cooling liquid supply line 54 in the support structure 64. The flow outlets 22 in each laser diode module 12 are connected in parallel to a cooling liquid return line 56 in the support structure. Linking members 58 (i.e., FIG. 4b) are provided to electrically connect an anode heat sink 10 of one module 12 to a cathode heat sink 11 of an adjacent module 12.

As shown in FIG. 5, a module generally indicated at 68, may include a heat spreader 72 adjacent to a laser diode bar 74 and between a heat sink 70 and the laser diode bar 74. The heat spreader 72 is of a dissimilar material such as CVD diamond from the heat sink 70. The heat spreader 72 has a thermal conductivity that is higher than the heat sink 70 on which it is mounted to distribute the heat load over a larger area of the heat sink 70. An insulator 76 insulates the heat sink 70 from a heat sink 78, O-rings 80 and 82 fluidly seal the module 68 and cooling fluid flows through a cooling channel 83.

The diodes and their heat sinks may alternatively be connected in parallel. FIG. 6 shows multiple diode bars 84, side-by-side, in an array similar to that shown in FIGS. 4a-4c. A single heat sink is used above the diode bars 84 and a single heat sink is used below the diode bars 84. More than one of the diode bars 84 is mounted to each heat sink 86. As before, an insulator 88 insulates anode from cathode heat sinks 86 and O-rings 90 provide fluid sealing of a cooling channel 92. A bolt hole 94 is centrally provided through each heat sink 86 for receiving a bolt (not shown) therein.

While the best mode for carrying out the invention has been described in detail, those familiar with the art to which this invention relates will recognize various alternative designs and embodiments for practicing the invention as defined by the following claims.

What is claimed is:

1. A method for cooling at least one laser diode with a cooling fluid which does not come into direct contact with the at least one laser diode, the method comprising:
providing a source of cooling fluid;
positioning heat sinks on opposing sides of the at least one laser diode wherein each of the heat sinks has a passage formed therein and wherein the passages are in fluid communication with the source of cooling fluid but not with the at least one laser diode; and
circulating the cooling fluid through the passages wherein heat is removed from the sides of the at least one laser diode by conduction into the heat sinks and wherein heat is removed from the heat sinks by the cooling fluid via forced convection.

2. The method as claimed in claim 1 further comprising the step of electrically and thermally bonding the heat sinks to the at least one laser diode.

3. The method as claimed in claim 1 wherein the heat sinks serve as electrical connections to and from the at least one laser diode.

4. The method as claimed in claim 1 wherein at least one of the heat sinks has a heat spreader and wherein the method further comprises positioning the heat spreader adjacent the at least one laser diode wherein the heat spreader is made of a material different than the material of the at least one heat sink.

5. A method for cooling an array of laser diodes with a cooling fluid which does not come into direct contact with the laser diodes, the method comprising:
providing a source of cooling fluid;
positioning heat sinks on opposing sides of each of the laser diodes such that each heat sink is in contact with a single laser diode and wherein each of the heat sinks has a passage formed therein and wherein the passages are in fluid communication with the source of cooling fluid but not with the laser diodes; and
circulating the cooling fluid through the passages wherein heat is removed from the sides of each of the laser diodes by conduction into the heat sinks and wherein heat is removed from the heat sinks by the cooling fluid via forced convection.

6. The method as claimed in claim 5 further comprising the step of electrically and thermally bonding the heat sinks to their respective laser diodes.

7. The method as claimed in claim 5 wherein the heat sinks serve as electrical connections to and from their respective laser diodes.

8. The method as claimed in claim 7 wherein each of the heat sinks for a given laser diode is in electrical contact with either a heat sink associated with a different laser diode or with an electrical supply such that multiple laser diodes are electrically connected in series or in parallel.

9. The method as claimed in claim 5 wherein at least one of the heat sinks has a heat spreader and wherein the method further comprises positioning the heat spreader adjacent its laser diode wherein the heat spreader is made of a material different than the material of the at least one heat sink.

10. A system for cooling at least one laser diode with a cooling fluid which does not come into direct contact with the at least one laser diode, the system comprising:
a source of cooling fluid;
a plurality of heat sinks in thermal contact with opposing sides of the at least one laser diode, each of the heat sinks having a passage formed therein and wherein the passages are in fluid communication with the source of cooling fluid but not with the at least one laser diode; and
a mechanism for circulating the cooling fluid through the passages wherein heat is removed from the sides of the at least one laser diode by conduction into the heat sinks and wherein heat is removed from the heat sinks by the cooling fluid via forced convection.

11. The system as claimed in claim 10 wherein each of the passages includes a flow inlet and a flow outlet and wherein the flow inlets are fluidly coupled to each other and the flow outlets are fluidly coupled to each other.

12. The system as claimed in claim 11 further comprising a support structure for supporting the heat sinks and wherein the support structure includes at least one cooling liquid line fluidly coupled to the passages of the heat sinks.

13. The system as claimed in claim 10 further comprising a support structure for supporting the heat sinks wherein each of the passages includes a flow inlet and a flow outlet and wherein the support structure includes a cooling liquid supply line fluidly coupled to each of the flow inlets and a cooling liquid return line fluidly coupled to each of the flow outlets.

14. The system as claimed in claim 10 wherein the heat sinks are bonded to the at least one laser diode with solder or an electrically and thermally conducting adhesive.

15. A system for cooling an array of laser diodes with a cooling fluid which does not come into direct contact with the laser diodes, the system comprising:
a source of cooling fluid;
a plurality of heat sinks in thermal contact with opposing sides of each of the laser diodes wherein each heat sink is in contact with a single laser diode, each of the heat sinks having a passage formed therein and wherein the passages are in fluid communication with the source of cooling fluid but not with the laser diodes; and
a mechanism for circulating the cooling fluid through the passages wherein heat is removed from the sides of each of the laser diodes by conduction into the heat sinks wherein heat is removed from the heat sinks by the cooling fluid via forced convection.

16. The system as claimed in claim 15 wherein each of the passages includes a flow inlet and a flow outlet and wherein the flow inlets are fluidly coupled to each other and the flow outlets are fluidly coupled to each other.

17. The system as claimed in claim 16 further comprising a support structure for supporting the heat sinks and wherein the support structure includes at least one cooling liquid line fluidly coupled to the passages of the heat sinks.

18. The system as claimed in claim 15 further comprising a support structure for supporting the heat sinks wherein each of the passages includes a flow inlet and a flow outlet and wherein the support structure includes a cooling liquid supply line fluidly coupled to each of the flow inlets and a cooling liquid return line fluidly coupled to each of the flow outlets.

19. The system as claimed in claim 15 further comprising at least one fastener for removably fastening the heat sinks together.

20. The system as claimed in claim 15 wherein the heat sinks are bonded to their respective laser diodes with solder or an electrically and thermally conducting adhesive.
